(19) United States
(12) Patent Application Publication
(10) Pub. No.: US 2008/0212883 A1
(43) Pub. Date: Sep. 4, 2008

(54) Processing Method of Data Structure for Real-Time Image Processing

(75) Inventor: Se Hyoung Park, Daejeon (KR)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: PIXONEER GEOMATICS, INC., Daejeon (KR)

(21) Appl. No.: 12/063,700

(22) PCT Filed: Aug. 17, 2006
(86) PCT No.: PCT/KR2006/003216

§ 371 Date: Feb. 13, 2008

(30) Foreign Application Priority Data
Aug. 17, 2005 (KR) 10-2005-0075053
Jul. 19, 2006 (KR) 10-2006-0067379

(51) Int. Cl. G06K 9/36; G06K 9/32

(52) U.S. Cl. 382/232; 382/299

(57) ABSTRACT

The present invention relates to a method of processing a data structure for real-time image processing of huge-sized data, where the data structure of an original image comprising a plurality of pixels is processed, the method comprising the steps of: rearranging the plurality of pixels according to an index indicating the location of each pixel and determining the data containing the rearranged pixels as a region having a resolution lower than that of the original image; and recursively performing a transforming process of rearranging a part or all of the data containing the rearranged pixels in the aforementioned rearranging method and determining the rearranged data as a region having a resolution lower than that of the previous region, until a predetermined resolution is obtained. In addition, in the present invention, the transformed data is compressed, and transmitted and received through a wired or wireless transmission network, and the receiving side decompresses, inverse transforms and restores, and displays the data.

### TECHNICAL FIELD

The present invention relates to a method of processing a data structure for real-time image processing of huge-sized data.

### BACKGROUND ART

Recently, due to advancements in technologies, high resolution images are widely utilized for medical, engineering and military purposes, and the amount of image data is also geometrically increasing in proportion to increase in necessities.

According to this, introduced is a variety of image processing and analyzing software for efficiently handling such huge-sized image data. However, since conventional data processing methods use existing original image data as it is, real-time processing is difficult to attain as the amount of data increases. Even though some methods for manipulating data have been proposed in order to process data in near real-time, it cannot practically stay out of applying conventional technologies for compressing and restoring still images, such as JPEG standards or the like, and thus cannot efficiently cope with processing high resolution images in real-time.

For example, according to a conventional method of processing huge-sized data, additional data, such as an image pyramid, a mipmap or the like, is inevitably required at each resolution level in order to process huge-sized data, and thus approximately 40% of additional data is further needed separately. Therefore, if original data is a huge-sized image file, the size of the additional data cannot be ignored, thereby imposing a great burden when it is transmitted through a transmission network.

Therefore, together with contriving efficient data structures for processing huge-sized data in real-time, developing image reproducing methods for processing the huge-sized data in real-time using the data structures on a computer is recognized as a common urgent technical task of related industries.

Meanwhile, four conditions described below are required in order to process huge-sized data in real-time. FIGS. 1 (a) to (c) are schematic views illustrating those conditions.

First, real-time resolution scalability should be satisfied. The real-time resolution scalability is the ability of obtaining data in real-time, gradually from a low resolution to a maximum resolution or arbitrarily. FIG. 1 (a) shows original image data transformed into a plurality of low resolution data.

Second, a region of interest (ROI) should be extracted in real-time. That is, the ROI should be extracted in real-time, and in the process of decompressing, only a specific portion of data should be decompressed and extracted by the resolution. FIG. 1 (b) shows extracting an ROI from original image data in real-time.

Third, an embedded characteristic should be provided. It is a characteristic of obtaining higher resolution data by adding additional data to lower resolution data, not abandoning the lower resolution data, in order to obtain the higher resolution data. FIG. 1 (c) shows the process of obtaining higher resolution data by adding “data 2” to “data 1”. This is an important characteristic that prevents efficiency of data transmission from being reduced due to resolution.

Fourth, additional data should not be added to original image data in order to implement the resolution scalability. However, as described above, according to generally used technologies, additional data, such as an image pyramid or the like, is required for each resolution level in order to implement the resolution scalability, and thus approximately 40% of additional data is further needed, thereby imposing a great burden if the original image data is huge-sized data.

Compression and restoration methods have been used in order to evade such a burden. However, compression is a method that inevitably modifies a portion of data values by calculation, not preserving the original data as it is, and thus it is unsuitable for medical, scientific, engineering, and military purposes that require high resolution displays, and the real-time resolution scalability cannot be implemented only through the compression.

### DISCLOSURE

### Technical Problem

Accordingly, the present invention has been made in order to solve the above problems, and it is an object of the invention to provide a data structure for reproducing and processing images of a desired resolution in real-time, without being limited in the size of data, and a method of processing thereof.

Another object of the invention is to provide a method of processing a data structure, in which huge-sized data of an original image transformed on the basis of the method of processing a data structure is transmitted and received through a transmission network and processed in real-time.

### Technical Solution

The present invention relates to a method of processing a data structure transformed such that data is embedded in the data structure itself by the resolution in advance for real-time image processing of huge-sized data comprising a plurality of pixels.

In addition, the present invention relates to a method of processing a data structure, in which huge-sized data of an original image transformed on the basis of the method of processing a data structure is transmitted and received through a transmission network and processed in real-time.

In order to accomplish the above objects of the invention, according to one aspect of the invention, there is provided a method of processing a data structure, where the data structure of an original image comprising a plurality of pixels is processed, the method comprising the steps of: rearranging the plurality of pixels according to an index (location element value) indicating the location of each pixel and determining the data containing the rearranged pixels as a region having a resolution lower than that of the original image; and recursively performing a transforming process of rearranging a part or all of the data containing the rearranged pixels in the aforementioned rearranging method and determining the rearranged data as a region having a resolution lower than that of the previous region, until a predetermined resolution is obtained.

In addition, the data structure can be two-dimensional, which can be rearranged into four regions having values of (0, 0), (1, 0), (0, 1), and (1, 1) respectively according to the remainder of dividing the index by two. Alternatively, the data structure can be three-dimensional, which can be rearranged into eight regions having values of (0, 0, 0), (0, 0, 1), (0, 1, 0), (0, 1, 1), (1, 0, 0), (1, 0, 1), (1, 1, 0), and (1, 1, 1) respectively according to the remainder of dividing the index by two. In addition, in the process of transforming, the rearranged regions are preferably tiled within the region.

In addition, the method of processing a data structure is performed by a certain system comprising at least a processor, input means, and display means, wherein a region of interest of the original image displayed on the display means is selected and inputted into the processor by the input means, and after restoring the data structure by sequentially inverse transforming the data structure within the region of interest in the reverse order of the transforming process and additionally combining the inverse transformed data structure starting from at least a lower resolution, the processor can display the restored data structure on the display means. In addition, the system includes, but is not limited to, all kinds of computers, as well as all kinds of display devices or communication devices, such as wired or wireless terminals or wired or wireless communication equipments attached with a display device.

In addition, according to another aspect of the invention, there is provided a method of processing a data structure for real-time image processing, where a server connected to a client through a wired or wireless transmission network rearranges, within the data structure of an original image, a plurality of pixels according to an index indicating the location of each pixel, and determines the data containing the rearranged pixels as a region having a resolution lower than that of the original image, recursively performs a transforming process of rearranging a part or all of the data containing the rearranged pixels in the aforementioned rearranging method and determining the rearranged data as a region having a resolution lower than that of the previous region until a predetermined resolution is obtained, and compresses the transformed data, the method comprising the steps of: requesting, by the client, a region of interest of the original image from the server through the transmission network; extracting, by the server, at least one or more compressed data of the requested region of interest and sequentially transmitting the compressed data to the client through the transmission network; sequentially receiving and decompressing, by the client, at least one or more of the compressed data and checking whether or not the requested resolution level is satisfied; and if the requested resolution level is satisfied, immediately processing or displaying, by the client, the decompressed data in real-time, or if the requested resolution level is not satisfied, after restoring the data to the requested resolution level by sequentially inverse transforming at least one or more of the decompressed data in the reverse order of the transforming process and additionally combining the inverse transformed data starting from at least a lower resolution, processing or displaying, by the client, the restored data in real-time.

In addition, according to another aspect of the invention, there is provided a method of processing a data structure for real-time image processing, where a server connected to a client through a wired or wireless transmission network rearranges, within the data structure of an original image, a plurality of pixels according to an index indicating the location of each pixel, and determines the data containing the rearranged pixels as a region having a resolution lower than that of the original image, recursively performs a transforming process of rearranging a part or all of the data containing the rearranged pixels in the aforementioned rearranging method and determining the rearranged data as a region having a resolution lower than that of the previous region until a predetermined resolution is obtained, and compresses the transformed data, the method comprising the steps of: requesting, by the client, a region of interest of the original image from the server through the transmission network; extracting, by the server, at least one or more compressed data of the requested region of interest and sequentially transmitting the compressed data to the client through the transmission network; and sequentially receiving and decompressing, by the client, at least one or more of the compressed data, restoring data by sequentially and recursively inverse transforming at least one or more of the decompressed data in the reverse order of the transforming process until at least one or more pixels arrive at the resolution of the original image and additionally combining the inverse transformed data starting from at least a lower resolution, and processing or displaying the restored data in real-time.

### ADVANTAGEOUS EFFECTS

The method of processing a data structure for real-time image processing can process an image of a desired resolution without losing data values, through EPOT transformation and EPOT inverse transformation, and a tiling process.

In addition, the present invention can EPOT transform and compress an image of a desired resolution without losing image data values and efficiently transmit, through a transmission network, huge-sized data where an image data level is embedded, and provides an efficient image processing basis, in which the huge-sized data can be received and processed at a requested resolution in real-time.

Accordingly, since the method of the present invention can be processed in real-time, it can be conveniently used for generally compressed image file formatting, real-time service of huge-sized image data through the Internet, local and Internet visualization of scientific and engineering data, altitude data and image data formatting for three-dimensional virtual environments, electronic books, and the like.

### DESCRIPTION OF DRAWINGS

Further objects and advantages of the invention can be more fully understood from the following detailed description taken in conjunction with the accompanying drawings in which:

FIG. 1 is a schematic view illustrating conditions for processing huge-sized data in real-time;

FIG. 2 is a graph illustrating interrelationship between the LOD and ROI;

FIG. 3 is a conceptual view illustrating a tiled data structure and a non-tiled data structure;

FIG. 4 is a view illustrating a method of EPOT transformation and EPOT inverse transformation for a one-dimensional data structure according to an embodiment of the invention;

FIGS. 5 to 7 are views illustrating a method of EPOT transformation and EPOT inverse transformation for a two-dimensional data structure according to an embodiment of the invention;

FIG. 8 is a view illustrating ROIs of respective sublevels of an EPOT data structure transformed up to level 2 after an ROI is determined at an original resolution;

FIG. 9 is a view illustrating a tiling process and performance compared according to the tiling process;

FIG. 10 is a view schematically illustrating EPOT transformation of a three-dimensional data structure according to an embodiment of the invention;

FIG. 11 shows flowcharts for comparing the processing sequences of a conventional data processing method and the EPOT transformation method according to the present invention;

FIG. 12 is a flowchart illustrating a method of transmitting EPOT transformed data through a transmission network according to an embodiment of the present invention;

FIGS. 13 and 14 are views and a flowchart illustrating a method of processing a data structure in an embodiment of the present invention, where an EPOT transformed one-dimensional data structure of an original image data is transmitted, received, inverse transformed, and restored; and

FIGS. 15 to 17 are views and a flowchart illustrating a method of processing a data structure in an embodiment of the present invention, where an EPOT transformed two-dimensional data structure of an original image data is transmitted, received, inverse transformed, and restored.

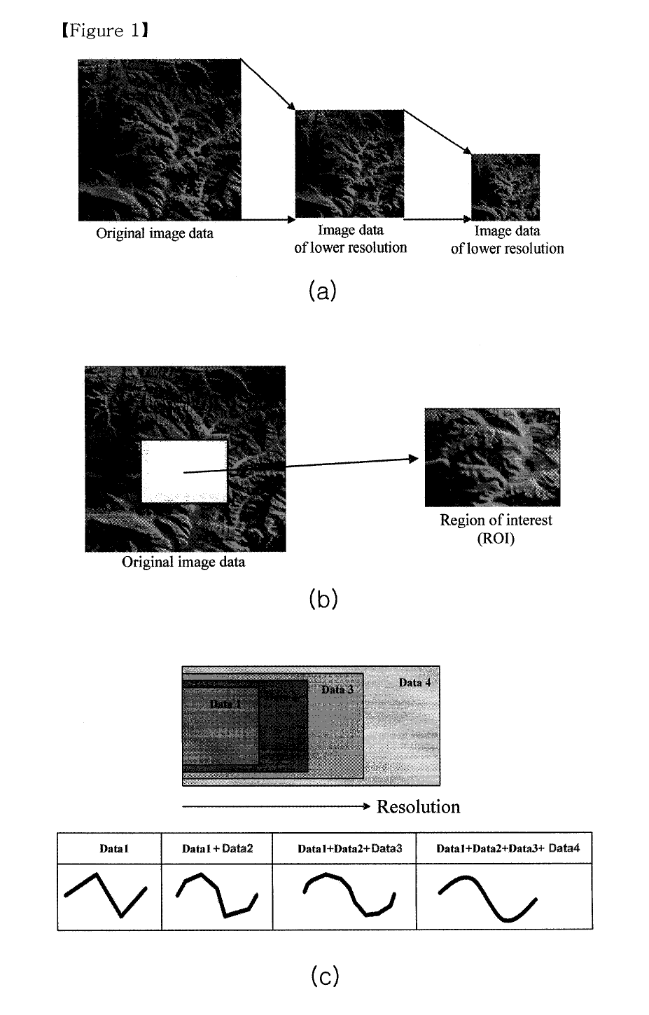

### MODE FOR INVENTION

Hereinafter, the preferred embodiments of the present invention will be described in detail with reference to the accompanying drawings.

According to the present invention, the method of processing a data structure for real-time image processing reconfigures the data structure of an original image comprising a plurality of pixels by changing the order of the pixels. The data structure of the original image reconfigured as such is already embedded with data in itself by the resolution and thus additional data of an image pyramid is not needed separately. Therefore, the data can be read by a reading device of a computer at a high speed, and thus huge-sized image data can be processed in real-time. When processing particularly two- or three-dimensional huge-sized data, the method does not read a large amount of data as a conventional method does, and thus computing speed is greatly improved and image processing can be performed in real-time.

In addition, in an embodiment of the present invention, first, the size of a region of interest to be displayed on a computer screen is determined by input means, which is a peripheral device of the computer. After only corresponding pixels of each resolution level are read from the data structure by the reading device and combined after being inverse transformed, the determined region of interest is displayed on the computer screen. Here, the input means for determining the size of a region of interest can be implemented, for example, through zoom-in and zoom-out functions of a mouse. In addition, the size of a region of interest can be determined by the coordinate values of the left upper corner and the right lower corner, or automatically determined as large as a predetermined region at a certain resolution level. In addition, the resolution level of the region of interest can be programmed so as to be automatically determined by the computer. Then, only corresponding pixels of each resolution level in the data structure are read by the reading device and combined after a certain inverse transforming process has been performed, and the determined region of interest is displayed on the computer screen. At this point, the inverse transforming process combines the data in order of starting from corresponding pixels of a lower resolution level to corresponding pixels of a higher resolution level. Accordingly, due to the data structure transformed as such, the reading device of the computer can read corresponding pixel information from the huge-sized data stored in a recording medium, and thus the process of displaying the information on the screen can be performed in real time. Here, the recording medium includes all kinds of general recording and storage media connected to a computer for reading and writing data, such as optical disks, e.g. a compact disk (CD), digital versatile disk (DVD), or the like, floppy disks, hard disks, flash memory, or the like.

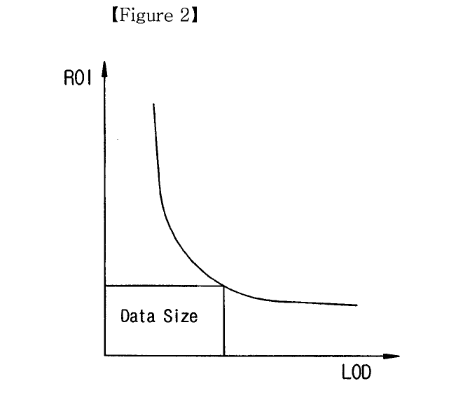

Huge-sized data can be processed in real-time with the current computing power using the transformed data structure of the present invention as described above, theoretically owing to the limit in size of a computer screen to be displayed. FIG. 2 is a graph illustrating this.

From the graph of FIG. 2, it is understood that a resolution level (LOD: level of detail) of data is inverse proportional to a region of interest (ROI) of the data that a user is interested in. The area of a rectangle, formed by a certain point on the inverse proportional curve, the LOD of the horizontal axis, and the ROI of the vertical axis, shows the amount of data to be processed by a computer. Whatever point may be selected from the inverse proportional curve, the area of the rectangle is the same, which means that the amount of data reproduced on a restricted area of a computer screen is less than a certain value regardless of the size of original data. Accordingly, however large the data may be, data of a small size and low resolution is needed if entire image data is displayed on the restricted screen, and a small amount of data of the region to be reproduced is needed among the entire data if image data is displayed so as to reproduce the original resolution as is. That is, regardless of the size of original data, the amount of image data to be displayed on the restricted area is uniform, which means that data can be processed and analyzed in real-time even with the current computing power.

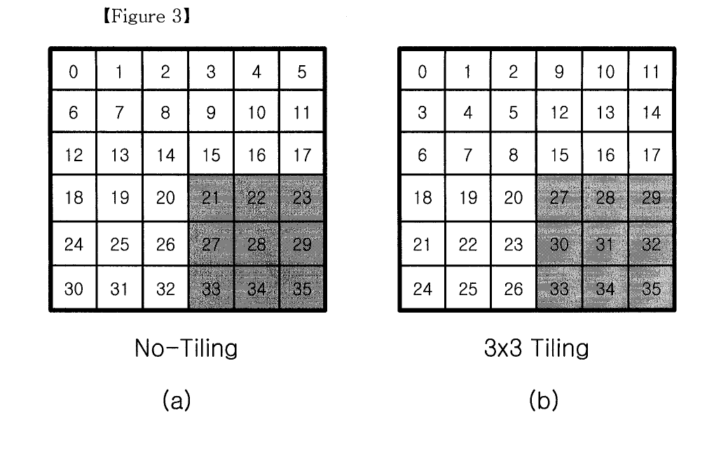

In addition, according to an embodiment of the present invention, it is preferable to have a tiled data structure in order to reduce the number of access to the data structure that a computer does to read the data of an original image comprising a plurality of pixels. FIG. 3 is a conceptual view illustrating a tiled data structure and a non-tiled data structure by comparison.

Tiling is a work of sorting data by rearranging pixels so that a storage device of a computer can easily access to the data. There is not a special problem if the amount of data stored in the storage device of a computer is small. However, in the case of two-dimensional, furthermore three-dimensional, huge-sized data, it is highly preferable to perform the tiling process by rearranging the pixels. That is, since two- or three-dimensional data is stored in the storage device of a computer in row order, when an ROI, which is a predetermined portion of data, is to be read from the huge-sized data, as much access as the number of rows of a stored array is needed. Therefore, if the data is not properly categorized by the region, the burden of time on reading the ROI by the computer becomes a great obstacle to real-time processing, which invites a very serious situation in the case of three-dimensional, especially huge-sized data.

Referring to FIG. 3 (a) of non-tiled data, if a computer is to read the ROI displayed with a grey background, i.e. “21, 22, 23, 27, 28, 29, 33, 34, and 35”, it reads “21, 22, and 23” at a time, “27, 28, and 29” at the next time, and “33, 34, and 35” at the next time, and consequently, three consecutive accesses are needed in all.

Contrarily, referring to FIG. 3 (b) of tiled data, if a computer is to read the ROI displayed with a grey background, i.e. “27, 28, 29, 30, 31, 32, 33, 34, and 35”, only one access is needed in order of “27, 28, 29, 30, 31, 32, 33, 34, and 35”, and thus real-time processing can be performed at a high speed. At this point, the bigger the size of the tile is, the better the efficiency will be. However, the tile should be smaller than the size that can be read into memory, and if the size of the tile becomes small, the number of access to the disk increases, so that an appropriate compromise is needed. In addition, an image to which the tiling is applied can be an arbitrary size, not a multiple of the size of the tile. However, generally for the size of tile, a size of 64, 128, 256, 512, or the like, which is a multiple of 2ⁿ, can be selected and used.

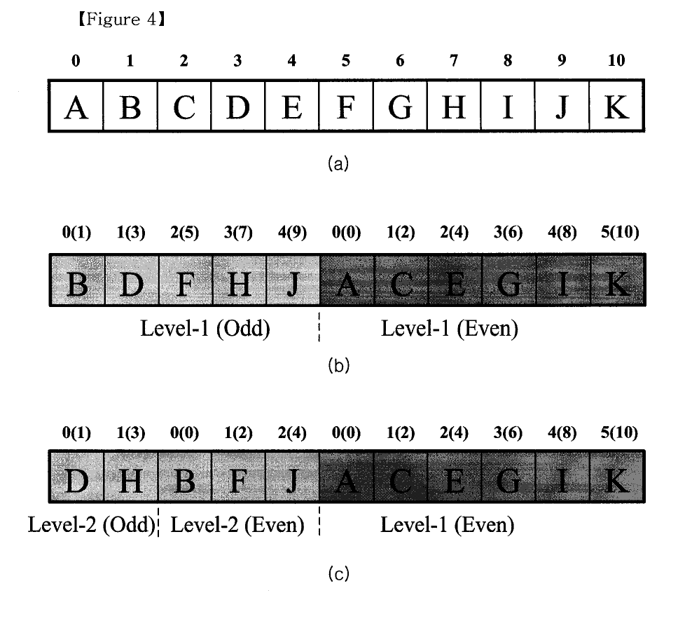

In addition, according to an embodiment of the present invention, if the original image has a one-dimensional data structure, it can be preferably transformed by the method described below. The embedded pixel order transform (EPOT), which is a method of transforming the data structure of an original image according to the present invention, is a method of transformation implementing the LOD inside the data by changing the order of pixels (in the case of one- or two-dimension data) or voxels (in the case of three-dimensional data), by which the pixels are rearranged and thus data of a desired resolution level can be obtained. The order of each pixel is changed by the EPOT transformation. Odd-indexed and even-indexed pixels are categorized into layers at the LOD of each resolution level respectively. FIG. 4 is a view illustrating the method of EPOT transformation and EPOT inverse transformation for a one-dimensional data structure according to an embodiment of the invention.

First, FIG. 4 (a) shows pixels of a one-dimensional data structure having eleven elements.

Here, if pixels in the data structure are categorized into odd-indexed (O) pixels and even-indexed (E) pixels, combined together, and transformed, the data structure is transformed as shown in FIG. 4 (b). That is, five data on the left side (B, D, F, H, and J) and six data on the right side (A, C, E, G, I, and K) are in a stage of having been passed through a first transformation as described, and thus they become data of resolution level 1 having a resolution that is one level lower than that of the original data of resolution level 0.

In addition, the numerals in the parentheses of FIG. 4 (b) denote location indexes at the higher level.

Once again, while six data on the right side (A, C, E, G, I, and K) in the data structure of FIG. 4 (b) are left as they are, if five data on the left side (B, D, F, H, and J) are categorized into odd-indexed pixels and even-indexed pixels, combined together, and transformed in the same manner as described above, the data structure is transformed as shown in FIG. 4 (c). Accordingly, the leftmost two data (D and H) and next three data (B, F, and J) are in a stage of having been passed through a second transformation as described above, and thus they become data of resolution level 2 having a resolution that is one level lower than that of level 1. Accordingly, the data structure in FIG. 4 (c) comprises level 2 (odd) data (D and H), level 2 (even) data (B, F, and J), and level 1 (even) data (A, C, E, G, I, and K).

As described above, the resolution level of the original image is 0, and the data EPOT transformed therefrom becomes such that the degree of the resolution level increases in order of level 1, 2, 3, . . . , and n according to the number of transformation, whereas the resolution thereof gradually decreases. The number of such EPOT transformation can be arbitrarily adjusted according to the size of the original data. For example, if the size of the original data is very large, the number of transformation is increased so that the data can be transformed to have many resolution levels.

In addition, in an embodiment of the present invention, if data of a certain resolution level for an ROI of the original image is requested, only the data corresponding to the level needs to be read from the data structure, and thus the image is processed in a very speedy way. For example, if data of level 2 having a resolution lower than the original resolution of level 0 is requested, only data D, H, and F of level 2 need to be read. In this case, the resolution of the displayed image is lower than the original resolution.

In addition, in an embodiment of the present invention, the transformed data can be restored and reproduced at a desired resolution level in a speedy way. That is, for example, if an ROI comprises D, E, F, G, and H in FIG. 4 (a), and the pixels are desired to be restored to the resolution of the original image of level 0, since E(2) and G(3) are level 1(E), D(0) and H(1) are level 2(O), and F(1) is level 2(E), data D, H, and F of level 2 are inverse transformed and restored to the odd part of level 1 as shown in FIG. 4 (b) referring to the indexes in the parentheses. Next, if the restored data is EPOT inverse transformed and reconfigured, together with data E and G of the even part of level 1, data having the resolution of the original image of level 0 is restored finally. Of course, the step of the inverse transforming is needed only when the requested final resolution level is level 0, and at the other resolution levels lower than level 1, the data corresponding to the level only needs to be read directly without performing inverse transformation. Consequently, in the case of FIG. 4 (c), data of all resolutions, in the range from level 0 to level 2, can be processed and read in real-time.

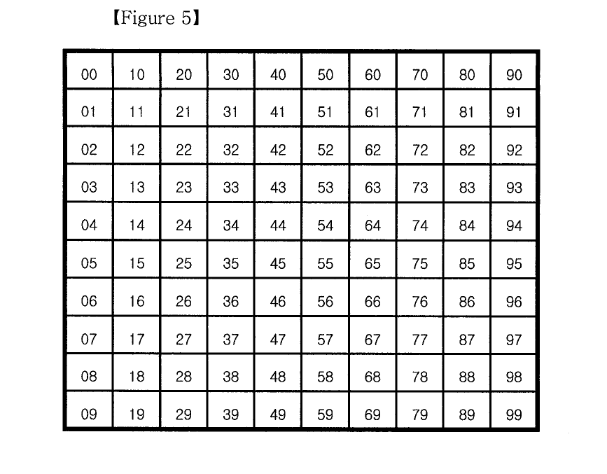

In addition, according to an embodiment of the present invention, if the original image has a two-dimensional data structure, it can be preferably transformed by the method described below. FIGS. 5 to 7 are views illustrating the method of EPOT transformation and EPOT inverse transformation for a two-dimensional data structure according to an embodiment of the invention.

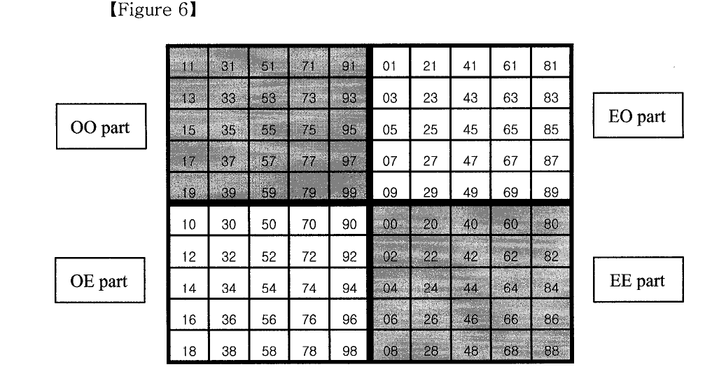

FIG. 5 shows a two-dimensional data structure arranged in the direction of the x-axis and y-axis. At this point, pixels are categorized into odd-indexed (O) pixels and even-indexed (E) pixels in the direction of the x-axis, combined together, and transformed, and then categorized into odd-indexed (O) pixels and even-indexed (E) pixels in the direction of the y-axis, combined together, and firstly transformed as shown in FIG. 6. The two-dimensional data structure in FIG. 6 is transformed and divided into four regions of OO (Odd-Odd) part, EO (Even-Odd) part, OE (Odd-Even) part, and EE (Even-Even) part, each part of which is at level 1 having a resolution that is one level lower than that of the original image of level 0.

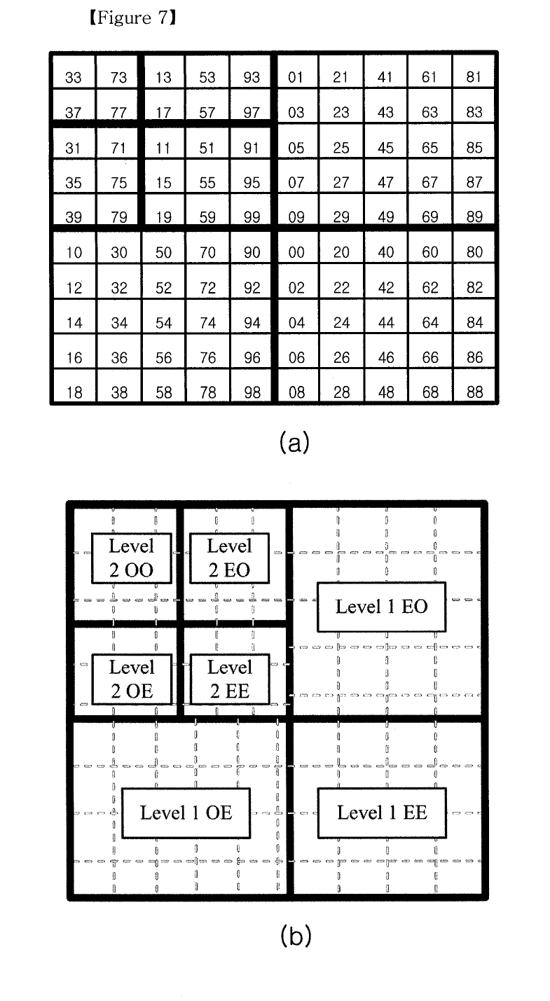

Next, the data structure is secondly transformed into level 2 as shown in FIG. 7 (a), which is schematically shown in FIG. 7 (b) for convenience. That is, it is understood that there are three mipmaps (EO, OE, and EE) for each region of level 1 and four mipmaps (OO, EO, OE, and EE) for each region of level 2, the resolution of which is one level lower than that of level 1.

In addition, according to an embodiment of the present invention, the data transformed from such a two-dimensional data structure can be restored by the same inverse transformation method as described for the one-dimensional data structure. A certain ROI determined from the data structure of the original image is preferably transformed as described below.

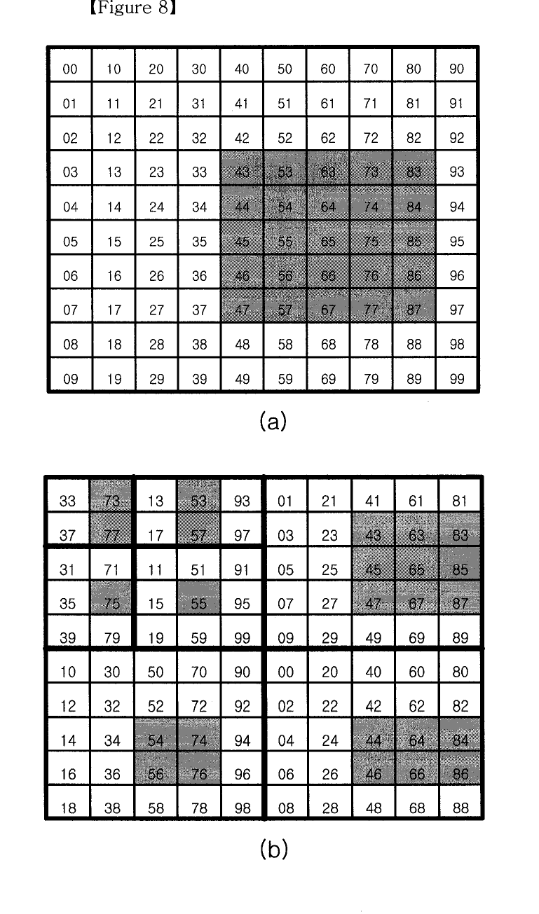

FIG. 8 is a view illustrating ROIs of respective sublevels of an EPOT data structure transformed up to level 2 after an ROI is determined at an original resolution. That is, FIG. 8 (a) shows an example of an ROI determined in the range of 4 to 8 in the x-axis direction and 3 to 7 in the y-axis direction at the original resolution. When the ROI is extracted at the resolution of level 0, the ROI at each sublevel of the EPOT data structure transformed up to level 2 is shown in FIG. 8 (b). This can be expressed as shown below.

level 1 (EE)→X: 2˜4, Y: 2˜3 (coordinate 1)

level 1 (EO)→X: 2˜4, Y: 1˜3 (coordinate 2)

level 1 (OE)→X: 2˜3, Y: 2˜3 (coordinate 3)

level 2 (EE)→X: 1, Y: 1 (coordinate 4)

level 2 (EO) X: 1, Y: 0˜1 (coordinate 5)

level 2 (OE) X: 1, Y: 1 (coordinate 6)

level 2 (OO) X: 1, Y: 0˜1 (coordinate 7)

In order to obtain data of level 0 using these, inverse transformation is performed in a way similar to the aforementioned process of restoring a one-dimensional data. Specifically, from FIG. 8 (b), data of the OO part of level 1 is constructed first from the ROI data of level 2 (coordinates 4, 5, 6, and 7), and then final data of level 0 is obtained by combining the data of the OO part of level 1 and the ROI data of level 1 (coordinates 1, 2, and 3).

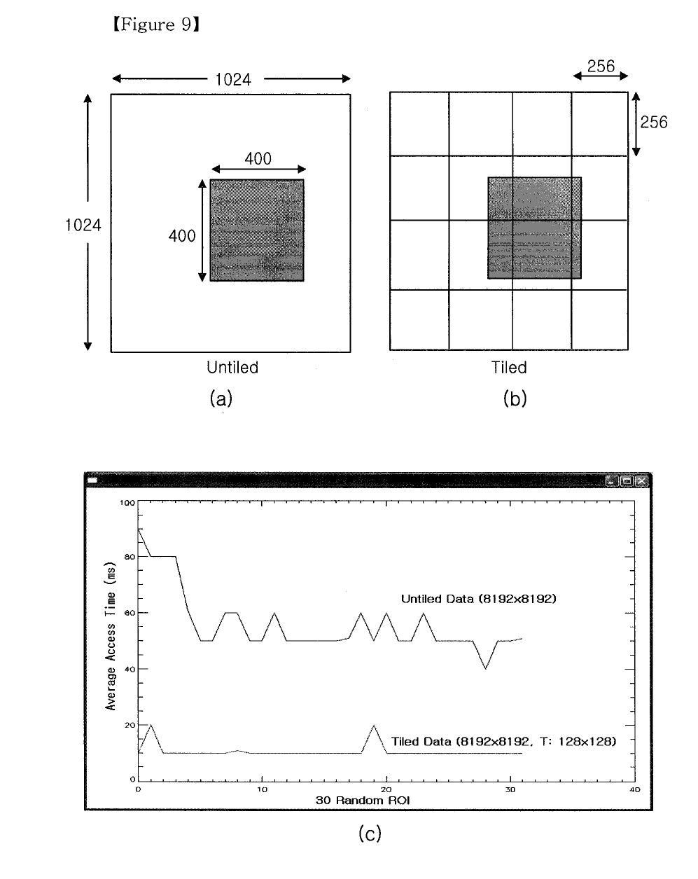

Then, since the EO, OE, and EE parts frequently have a very large two-dimensional data of huge-sized data in practice, according to an embodiment of the present invention, it is highly preferable to tile each of the above described parts. FIG. 9 is a view illustrating a tiling process and performance compared according to the tiling process. FIG. 9 (a) shows the case where a tiling process is not performed, and FIG. 9 (b) shows the data structure of an image where a tiling process is performed, in which the portion displayed with a grey background is an ROI.

That is, in order to estimate the degree of improvement in the speed of access to data when tiling is applied, it is assumed that the entire EE part is data having a size of 1,024×1,024 pixels. In addition, compared are the cases where an ROI of 400×400 pixels is read from both the non-tiled data structure (FIG. 9 (a)) and the data structure tiled in a size of 256×256 pixels (FIG. 9 (b)).

If the disk cache function of a system is excluded, data should be accessed as much as 400 times (corresponding to the height of the ROI) if the data is non-tiled as shown in FIG. 9 (a), whereas data need to be accessed only 6 times for the six tiles overlapped with or spread over the ROI if the data is tiled as shown in FIG. 9 (b). At this point, since cutting off unnecessary regions from the tiles that have been once read is performed within memory, it is considerably advantageous so as to be ignored compared in consuming time with the disk access described above.

In addition, FIG. 9 (c) shows the result of a test performed with certain sample data prepared for comparing performances resulting from whether or not the tiling process is performed. Here, randomly selected 30 ROIs of 256×256 size are read several times from non-tiled data of 8,192×8,192 size (about 64 M bytes) and the same data tiled in a size of 128×128, and averages thereof are calculated. Referring to FIG. 9 (c), it could be understood that in every region and attempt, tiled data saves extremely much time compared with non-tiled data. At this point, slow access time in the early stage is a phenomenon introduced by the process of the operating system starting to apply disk cache. It can be confirmed that if overall operation arrives at a stable state after a certain time has passed, accessing to tiled data is about 4 to 5 times faster than accessing to non-tiled data.

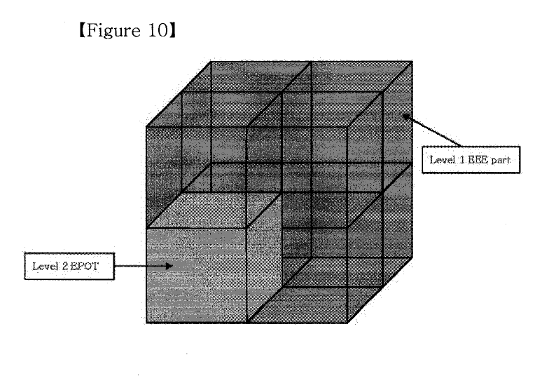

In addition, FIG. 10 is a view schematically illustrating a data structure implementing EPOT transformation for a construction comprising three-dimensional data, where the transformation is performed in the same manner as is performed for the one- or two-dimensional data. Those skilled in the art can readily embody such transformation referring to the one- or two-dimensional transformation process.

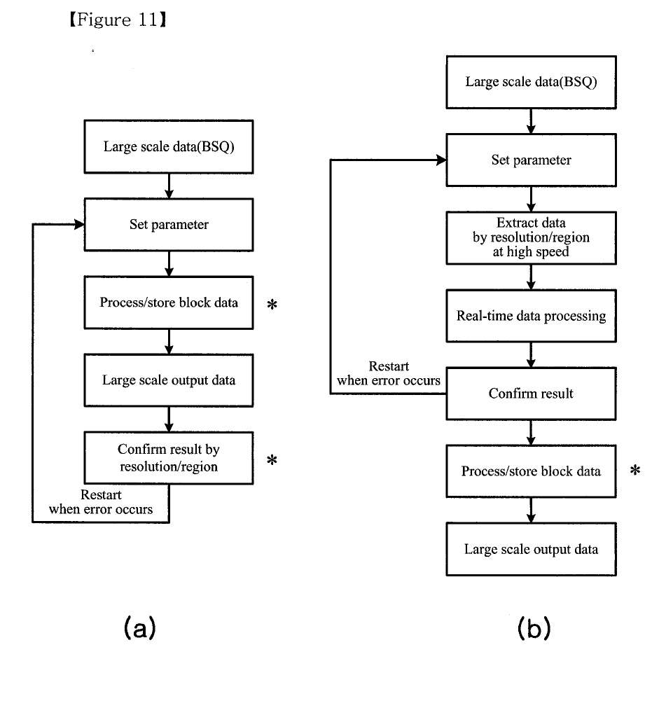

FIG. 11 shows flowcharts for comparing the processing sequences of a conventional data processing method and the EPOT transformation method according to the present invention. Particularly, FIG. 11 (a) shows the conventional data processing method, and FIG. 11 (b) shows the data transformation method according to the present invention.

Conventionally, huge-sized data is stored mostly in the band sequential (BSQ) method, which is a method that stores data sequentially from the first element to the last element. When using this method, entire data is sequentially read and recorded in an output file, and the output file is read again in order to confirm the data. Such a conventional data processing method takes a lot of time. Furthermore, as shown in FIG. 11 (a), if a result value is processed wrongly in the middle of the processing, it is inefficient in that the process unavoidably returns to the first step of the flowchart to redo the operation.

However, if the EPOT transformation method is applied to huge-sized data as described in the present invention, data can be extracted at a high speed by the resolution and region, and thus data of a region of interest, of a desired resolution is reproduced in real-time. Further, as shown in FIG. 11 (b), it is additionally advantageous in that the result can be confirmed before the huge-sized data is processed completely and stored as an output file. In FIG. 11, “*” symbol denotes a step consuming much time. FIG. 11 (a) shows the steps having a “*” symbol, where if an undesired result is obtained, a lot of time is consumed for a series of processes for changing setting values, reprocessing data, and storing the data. However, in FIG. 11 (b), since adopted is a sequence of opening data, processing and confirming the data in real-time, and storing a result if it is a desired one, there is not a step having a “*” symbol in the steps of trial and error, and time is consumed only for storing, and thus it is notably advantageous in the aspect of time saving.

In addition, Tables 1 and 2 described below show the result of measuring data processing time in the case where entire region and a portion of the region are extracted by the resolution. In order to get an objective test result, two experiments have been made, in which huge-sized data is firstly constructed through the EPOT transformation method according to the present invention, and secondly ROIs, together with general data stored in row order according to a conventional technique, are extracted at each resolution level and the results are compared with those of the present invention.

### <Sample Data>

EPOT transformation data: data EPOT transformed up to level 4, having the size of 8,192×8,192
Comparison data: data stored in row order, having the size of 8,192×8,192
Experiment system: Pentium-4 Mobile 1.2 GHz, RAM 512 MB, Windows XP

<Experiment 1>

Time taken for constructing data of entire region is measured ten times for each resolution, and an average of which (unit: msec) is calculated. A row skip method that skips a row is employed as a method for reducing resolution out of raw data. According to the results shown in Table 1, the difference is small at level 0 because of EPOT inverse transformation. However, in the case of level 2, 3, and 4, it can be confirmed that the EPOT transformation method according to the present invention is more than 10 times faster than the conventional one. The result is quite natural since data is already embedded in its own data structure by the resolution in the case of the EPOT transformation method.

TABLE 1

Average turnaround time
of 10 measurements (msec)

| Resolutions | row ordered data | EPOT data |
|---|---|---|
| 0 level: 8192 × 8192 data | 160.2 | 119.2 |
| 1 level: 4096 × 4096 data | 422.7 | 44.0 |
| 2 level: 2048 × 2048 data | 118.2 | 10.0 |
| 3 level: 1024 × 1024 data | 34.0 | 4 |
| 4 level: 512 × 512 data | 13.0 | 0.1 |

<Experiment 2>

This time, time taken for reading data of a portion of the region is measured for 40 randomly selected ROIs (512×512) at each resolution, and an average thereof is calculated.

### <Locations of ROIs>

X: 4169, 689, 7194, 5911, 2367, 5220, 7813, 6943, 4930, 833, 2182, 3563, 3225, 3395, 6116, 1238, 6658, 1188, 167, 4819, 2897, 164, 5898, 2836, 2649, 6638, 6351, 744, 1044, 5283, 3686, 6937, 1676, 1884, 3977, 4964, 4793, 4635, 1035, 7711
Y: 1705, 1836, 5283, 3755, 7405, 3845, 665, 4905, 1395, 4811, 614, 3595, 3209, 4289, 2377, 7292, 6626, 7621, 5956, 7022, 5199, 6327, 6210, 5471, 7748, 1723, 7680, 3694, 2745, 1752, 4174, 5650, 4626, 3041, 3397, 6313, 7059, 3675, 4501, 6977

TABLE 2

Average turnaround time
for reading 40 ROIs (msec)

| Resolutions | row ordered data | EPOT data |
|---|---|---|
| 0 level: 512 × 512 data | 70.1 | 10.2 |
| 1 level: 256 × 256 data | 21.0 | 2.0 |
| 2 level: 128 × 128 data | 7.0 | 0.9 |
| 3 level: 64 × 64 data | 3.0 | 0.4 |
| 4 level: 32 × 32 data | 2.8 | 0.8 |

According to the results shown in Table 2, it is understood that the speed of the EPOT transformation according to the present invention at level 0 is much faster than that of the conventional technique of row ordered data. This is because data is tiled in the EPOT transformation method, which saves time more than taken for inverse transformation.

Consequently, according to the results shown in Tables 1 and 2, the performance of the EPOT transformation method according to the present invention demonstrates outstandingly fast access time at all resolutions compared with that of conventional general row ordered data structure, and thus it can be confirmed that the EPOT transformation method provides a remarkably efficient data structure for processing huge-sized data in real-time.

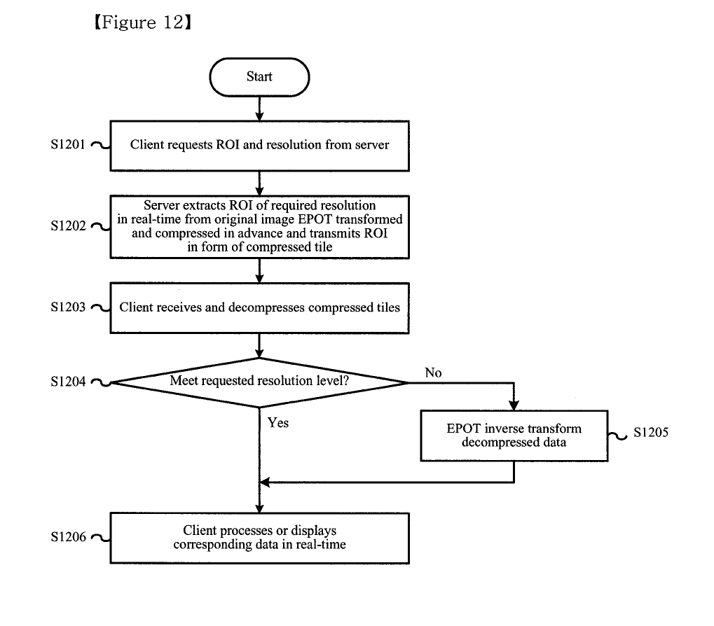

On the other hand, the method of EPOT transformation and EPOT inverse transformation described above is advantageous in transmitting data in real-time through a wired or wireless transmission network. That is, according to an embodiment of the present invention, the data structure of an original image is EPOT transformed, compressed, transmitted in real-time through a wired or wireless transmission network, received, decompressed in real-time, and inverse transformed. In this manner, data of a desired resolution can be obtained in real-time. FIG. 12 is a flowchart illustrating these processes.

First, a client requests an ROI of an original image and a resolution level thereof to a server through a transmission network (S1201). At this point, the transmission network includes general wired and wireless networks. In addition, the client can include a wired terminal having a desktop or a notebook computer, or a wireless terminal, such as a mobile communication terminal, handheld Internet terminal, wireless data communication terminal, or the like.

Here, the server, connected to the client through a wired or wireless transmission network, EPOT transforms and compresses the data structure of the original image in advance as described above. Accordingly, the server can provide in real-time the ROI corresponding to the resolution level requested by the client. A well-known compression method can be used as the compression method, including, for example, the wavelet transformation. In addition, the server preferably has a tiled and EPOT transformed data structure as described above.

Then, the server extracts in real time compressed and tiled data of the ROI requested by the client and transmits the data to the client (S1202).

Then, the client receives and decompresses the compressed data (S1203) and checks whether the requested final resolution level is satisfied (S1204). If the requested final resolution level is not satisfied, the client restores data by EPOT inverse transforming the decompressed data until the requested final resolution level is satisfied (S1205).

Then, if the requested final resolution level is satisfied, the client processes the data in real time or displays the data (S1206). At this point, as described below in detail, the EPOT transformed data can have a variety of resolution levels according to the size of the original data. For example, if the size of the original data is very large, the number of EPOT transformation thereof is increased so that the EPOT transformed data can have a resolution level having a smaller amount of data. Therefore, data can be inverse transformed and restored so as to meet the requested final resolution level, or data corresponding to the requested final resolution level can be directly read and displayed.

Alternatively, after restoring data by uniformly EPOT inverse transforming the data received from the server until the resolution level of the original image is reached, the client can process the data in real time or display the data.

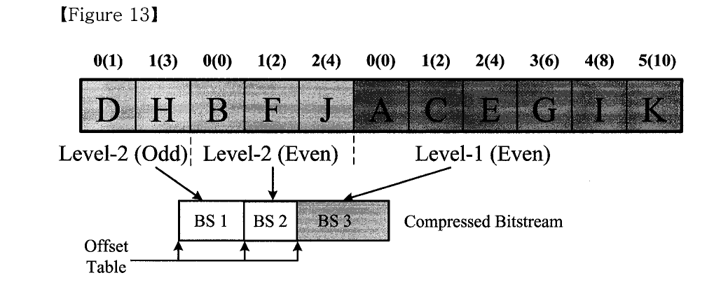

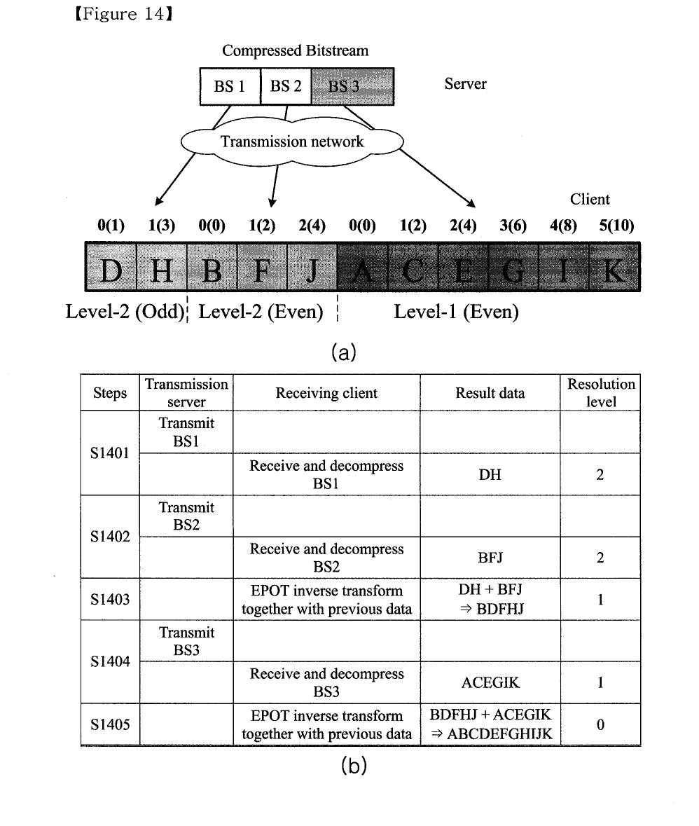

FIGS. 13 and 14 are views and a flowchart illustrating the method of processing a data structure in an embodiment of the present invention, where an EPOT transformed one-dimensional data structure of an original image data is transmitted, received, inverse transformed, and restored. In addition, this is associated with the EPOT transformation process of FIG. 4 described above.

First, the EPOT transformed one-dimensional data structure shown in FIG. 4 is compressed such that level 2(O), level 2(E), and level 1(E), which are regions of respective resolutions, are compressed into BS1, BS2, and BS3 respectively, and has an offset table for the starting point of each compressed region (BS: bit stream) as shown in FIG. 13.

Next, as shown in FIG. 14 (a), if the server, corresponding to a transmission side, transmits compressed bit streams of the ROI requested by the client, the client, corresponding to a receiving side, decompresses the received compressed bit streams and checks whether the resolution level of the decompressed data meets the requested resolution level. If the resolution level of the decompressed data meets the requested resolution level, the data corresponding to the final resolution level is directly read and displayed. If the resolution level of the decompressed data does not meet the requested resolution level, data is displayed after being inverse transformed and restored so as to meet the requested final resolution level. Alternatively, the client also can display data after restoring the data by decompressing the compressed bit streams received from the server and uniformly EPOT inverse transforming the decompressed data until the resolution level of the original image is reached.

In an embodiment of the present invention, if the resolution level to be restored by the client is level 0 of the original image level, data processing flow thereof can be expressed as shown in FIG. 14 (b). Here, previously EPOT transformed and compressed bit streams BS1, BS2, and BS3, which correspond to the ROI requested by the client, are sequentially transmitted from the server to the client respectively (S1401 to S1404).

First, the client receives BS1 from the server and obtains data DH of level 2 by decompressing the BS1 (S1401).

Subsequently, the client receives BS2 from the server and obtains data BFJ of level 2 by decompressing the BS2 (S1402).

Then, the client obtains data BDFHJ of level 1 by inverse transforming the data DH and BFJ of level 2 into previous locations referring to respective location indexes (S1403).

Then, the client receives BS3 from the server and obtains data ACEGIK of level 1 by decompressing the BS3 (S1404).

In addition, as described above, the client obtains data ABCDEFGHIJK of level 0 by inverse transforming the previous data BDFHJ and ACEGIK into previous locations referring to respective indexes, and processes or displays the level 0 data in real-time (S1405).

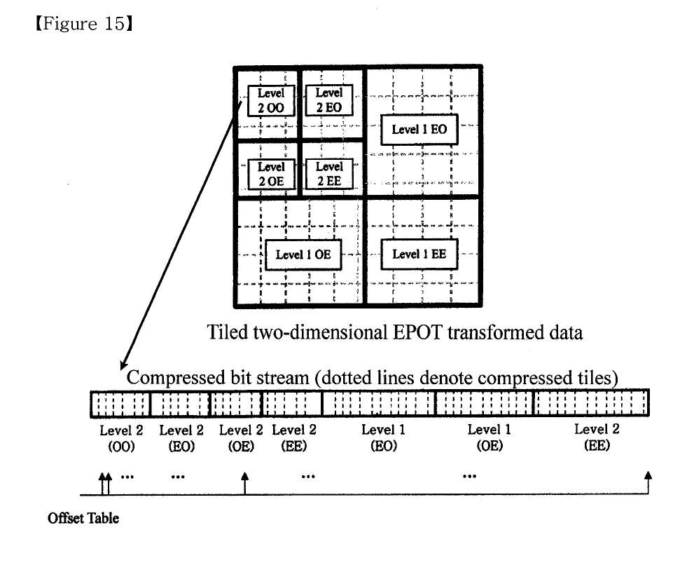

FIGS. 15 to 17 are views and a flowchart illustrating the method of processing a data structure in an embodiment of the present invention, where an EPOT transformed two-dimensional data structure of an original image data is transmitted, received, inverse transformed, and restored. In addition, this is associated with FIGS. 5 to 8 described above.

First, referring to FIG. 15, the EPOT transformed two-dimensional data structure of the original image includes data of level 2(OO), level 2(EO), level 2(OE), level 2(EE), level 1(EO), level 1(OE), and level 1(EE), i.e., regions of respective resolutions, which are compressed and sequentially stored. Then, the starting points of respective tiles are stored in the offset table.

If the server transmits compressed bit streams of the ROI requested by the client, the client decompresses the received compressed bit streams and checks whether the resolution level of the decompressed data meets the requested resolution level. If the resolution level of the decompressed data meets the requested resolution level, the data corresponding to the final resolution level is directly read and displayed. If the resolution level of the decompressed data does not meet the requested resolution level, data is displayed after being inverse transformed and restored so as to meet the requested final resolution level. Alternatively, the client also can display data after restoring the data by decompressing the compressed bit streams received from the server and uniformly EPOT inverse transforming the decompressed data until the resolution level of the original image is reached.

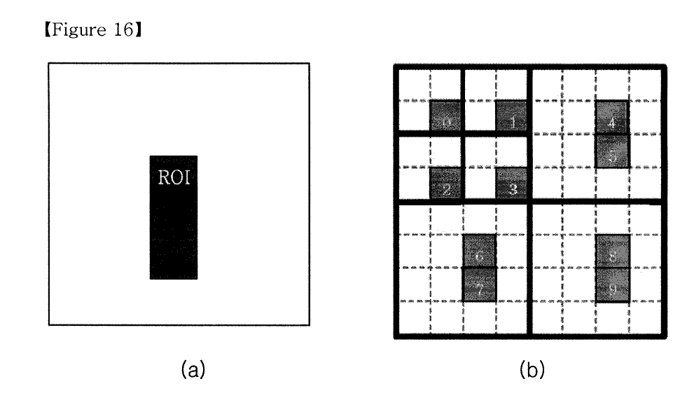

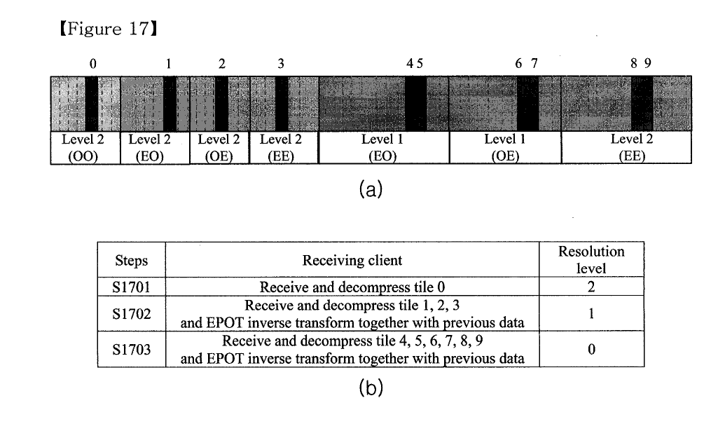

For example, in the case where the client requests the ROI shown in FIG. 16 (a), if it is assumed that the ROI has tiles 0 to 9 in respective resolution regions as shown in FIG. 16 (b), tile 0 exists in the level 2(OO) region, tile 1 in the level 2(EO) region, tile 2 in the level 2(OE) region, tile 3 in the level 2(EE) region, tile 4 and tile 5 in the level 1 (EO) region, tile 6 and tile 7 in the level 1(OE) region, and tile 8 and tile 9 in the level 1(EE) region. Such ten tiles are spread over seven regions of the compressed bit streams as shown in FIG. 17 (a). Accordingly, if the requested final resolution level is level 0 of the original image, the data of tiles 0 to 9 in the resolution regions are added in order starting from a lower resolution.

That is, referring to the flowchart of FIG. 17 (b), the server transmits tile 0 first, and the client receives and decompresses the tile 0, thereby obtaining data of resolution level 2 (S1701).

Then the client receives and decompresses tiles 1, 2, and 3 from the server, and EPOT inverse transforms the tiles together with the data of the previous step S1701 (S1702).

Then, subsequently, the client receives and decompresses tiles 4, 5, 6, 7, 8, and 9 from the server, and EPOT inverse transforms the tiles together with the data of the previous step S1702 (S1703). Then, the client processes or displays the obtained data in real-time.

As described above, the method of processing a data structure for real-time image processing according to the present invention can extract an ROI in real-time and obtain data thereof in real-time, gradually from a low resolution to a maximum resolution at a requested resolution level, or arbitrarily. In addition, a low resolution level can be arbitrarily extended without limit according to the amount of data of an original image.

Further, although one- and two-dimensional data have been exemplified as embodiments of the present invention, those skilled in the art can readily anticipate applicability of the present invention to three-dimensional voxel data and embody the present invention.

Further, as described above, in an embodiment of the present invention, the EPOT transformation of a data structure is combined with a tiling process, and thus a plurality of dispersed regions is tiled, so that the number of access to data can be minimally reduced. In the case of two- or three-dimensional huge-sized data, such tiling process recursively rearranges pixels, and thus the number of access to data is reduced, thereby reducing time taken for reading an ROI.

Although the present invention has been described with reference to several preferred embodiments, the description is illustrative of the invention and is not to be construed as limiting the invention. Various modifications and variations may occur to those skilled in the art, without departing from the scope of the invention as defined by the appended claims.

1. A method of processing a data structure, where the data structure of an original image comprising a plurality of pixels is processed, the method comprising the steps of:
rearranging the plurality of pixels according to an index indicating a location of each pixel and determining data containing the rearranged pixels as a region having a resolution lower than that of the original image; and
recursively performing a transforming process of rearranging a part or all of the data containing the rearranged pixels in the aforementioned rearranging method and determining the rearranged data as a region having a resolution lower than that of the previous region, until a predetermined resolution is obtained.

2. The method according to claim 1, wherein the data structure is two-dimensional, which is rearranged into four regions having values of (0, 0), (1, 0), (0, 1), and (1, 1) respectively according to a remainder of dividing the index by two.

3. The method according to claim 1, wherein the data structure is three-dimensional, which is rearranged into eight regions having values of (0, 0, 0), (0, 0, 1), (0, 1, 0), (0, 1, 1), (1, 0, 0), (1, 0, 1), (1, 1, 0), and (1, 1, 1) respectively according to a remainder of dividing the index by two.

4. The method according to any one of claims 1 to 3, wherein in the process of transforming, the rearranged regions are tiled within the region.

5. The method according to any one of claims 1 to 3, wherein the method of processing a data structure is performed by a certain system comprising at least a processor, input means, and display means, wherein a region of interest of the original image displayed on the display means is selected and inputted into the processor by the input means, and wherein after restoring the data structure by sequentially inverse transforming the data structure within the region of interest in a reverse order of the transforming process and additionally combining the inverse transformed data structure starting from at least a lower resolution, the processor displays the restored data structure on the display means.

6. A method of processing a data structure for processing images in real-time, where a server connected to a client through a wired or wireless transmission network rearranges, within the data structure of an original image, a plurality of pixels according to an index indicating a location of each pixel, and determines data containing the rearranged pixels as a region having a resolution lower than that of the original image, recursively performs a transforming process of rearranging a part or all of the data containing the rearranged pixels in the aforementioned rearranging method and determining the rearranged data as a region having a resolution lower than that of the previous region until a predetermined resolution is obtained, and compresses the transformed data, the method comprising the steps of:
requesting, by the client, a region of interest of the original image from the server through the transmission network;
extracting, by the server, at least one or more compressed data of the requested region of interest and sequentially transmitting the compressed data to the client through the transmission network;
sequentially receiving and decompressing, by the client, at least one or more of the compressed data and checking whether or not the requested resolution level is satisfied; and
if the requested resolution level is satisfied, immediately processing or displaying, by the client, the decompressed data in real-time, or if the requested resolution level is not satisfied, after restoring data to the requested resolution level by sequentially inverse transforming at least one or more of the decompressed data in a reverse order of the transforming process and additionally combining the inverse transformed data starting from at least a lower resolution, processing or displaying, by the client, the restored data in real-time.

7. A method of processing a data structure for real-time image processing, where a server connected to a client through a wired or wireless transmission network rearranges, within the data structure of an original image, a plurality of pixels according to an index indicating a location of each pixel, and determines data containing the rearranged pixels as a region having a resolution lower than that of the original image, recursively performs a transforming process of rearranging a part or all of the data containing the rearranged pixels in the aforementioned rearranging method and determining the rearranged data as a region having a resolution lower than that of the previous region until a predetermined resolution is obtained, and compresses the transformed data, the method comprising the steps of:
requesting, by the client, a region of interest of the original image from the server through the transmission network;
extracting, by the server, at least one or more compressed data of the requested region of interest and sequentially transmitting the compressed data to the client through the transmission network; and
sequentially receiving and decompressing, by the client, at least one or more of the compressed data, restoring data by sequentially and recursively inverse transforming at least one or more of the decompressed data in a reverse order of the transforming process until at least one or more pixels arrive at the resolution of the original image and additionally combining the inverse transformed data starting from at least a lower resolution, and processing or displaying the restored data in real-time.

8. The method according to claim 6 or 7, wherein the data structure is two-dimensional, which is rearranged into four regions having values of (0, 0), (1, 0), (0, 1), and (1, 1) respectively according to a remainder of dividing the index by two.

9. The method according to claim 6 or 7, wherein the data structure is three-dimensional, which is rearranged into eight regions having values of (0, 0, 0), (0, 0, 1), (0, 1, 0), (0, 1, 1), (1, 0, 0), (1, 0, 1), (1, 1, 0), and (1, 1, 1) respectively according to a remainder of dividing the index by two.

10. The method according to claim 6 or 7, wherein in the process of transforming, the rearranged regions are tiled within the region.
